(19) United States
(12) Patent Application Publication
(10) Pub. No.: US 2026/0118306 A1
(43) Pub. Date: Apr. 30, 2026

(54) SURFACE CAPABLE OF DETECTING LIQUID AND METHOD OF DETECTING LIQUID ON A SURFACE

(71) Applicant: AKZO NOBEL COATINGS INTERNATIONAL B.V., Amsterdam (NL)

(72) Inventors: Mina Abdolahzadeh, Amsterdam (NL); Pim Koeckhoven, Amsterdam (NL); Ravi Katti, Amsterdam (NL)

(21) Appl. No.: 19/470,240

(22) PCT Filed: Apr. 4, 2024
(86) PCT No.: PCT/EP2024/059173

§ 371 Date: Sep. 29, 2025

(30) Foreign Application Priority Data
Apr. 6, 2023 (EP) 23167012.6

(51) Int. Cl. G01N 27/22

(52) U.S. Cl. CPC G01N 27/223; G01N 27/226

(57) ABSTRACT

The disclosure relates to a surface capable of detecting liquid, the surface comprising:
a substrate;
optionally an insulating layer covering the substrate; and
a pair of spaced apart conductive lines deposited from a liquid conductive paint comprising a polymeric binder and a pigment, applied by brush, roller, or spray on the substrate or on the insulating layer,
   wherein the pair of conductive lines is electrically connected to a power source for providing an electric potential difference between the conductive lines in the pair and creating an electric field between the conductive lines in the pair, in such a way that the pair of conductive lines forms a capacitor in a capacitive measurement circuit wherein change in capacitance of the capacitor can be monitored.

The disclosure further relates to a method of detecting liquid using such surface.

### CROSS REFERENCE TO RELATED APPLICATION

This application is a 35 U.S.C. § 371 national phase application of PCT Application No. PCT/EP2024/059173 (published as WO/2024/208959), filed Apr. 4, 2024, which claims the benefit of priority to EP Application Serial No. 23167012.6, filed Apr. 6, 2023, each of which is incorporated herein by reference in their entirety.

### TECHNICAL FIELD

The present disclosure relates to a surface, in particular a floor, having a surface area, wherein at least part of the surface area is capable of detecting liquid, in particular water, so that leakage or spill of liquid on the surface can be detected, and to a method of detecting liquid on such surface.

### BACKGROUND

Leakage of water or other liquids is usually detected using small sensors that are placed in an apparatus or in a room, usually at a location close to possible leaks, such as below a tank or reactor or below an outlet of a tank or reactor.

Leak detection sensors for detecting liquid leakage wherein lines of conductive ink are printed on a polymeric base layer to form electrodes as part of a capacitive non-contact leakage sensor are known.

In KR102156129B1 is for example disclosed a small non-contact leak sensor comprising a first electrode formed on the top surface of a base film layer and a second electrode formed on the bottom surface of the base film layer. The electrodes are covered by a protective layer shaped with a thicker edge portion surrounding a central portion, so that a larger amount of leaked liquid is collected to increase the change in capacitance and therewith the accuracy of the sensor. The sensor is installed below a pipe connection in a supply pipe to a liquid storage tank.

In KR20150140007A is disclosed a leak detection sensor comprising conductive lines of a conductive fluorine-based synthetic resin printed on a base substrate of a non-conductive fluorine-based synthetic resin, and then sintered at high temperature. A plurality of such sensors is disposed in a structure at a location where leakage is expected.

In KR20170013811A is disclosed a strip-shaped leakage detection device that comprises sensing lines of stacked metal layers, each formed by vacuum deposition.

A disadvantage of the prior art liquid leakage sensors is that leakage is only detected at the location where the sensor is placed. The sensors are small, and the techniques used for forming the electrodes (printing and sintering or vacuum deposition) are not suitable for covering larger surfaces. There is a need to detect leakage or spill of liquid over larger surface areas, in particular larger surface areas of building surfaces such as floors, ceilings, and walls, with sufficient resolution.

### SUMMARY

It has now been found that a surface with a relatively large surface area, such as for example a floor, ceiling, or wall, can be made suitable for detecting liquid over its entire surface area or at least over a large part of its surface area. It has been found that a pair of conductive lines deposited from a conductive paint that is painted on the surface can act as an electric capacitor in a capacitive measurement circuit. When electrically connected to a power source, the pair of conductive lines will be electrically charged, establishing an electric potential difference and therefore an electric field between the conductive lines in the pair. It has been found that by monitoring capacitance of the capacitor formed by the conductive lines in the pair, the presence of liquid on the surface can be detected with sufficient resolution. Thus, the surface, such as for example a floor, on which one or more of such pairs of conductive lines are painted, can act as a capacitive sensor able to detect the presence of water or other liquids.

Accordingly, the disclosure provides in a first aspect a surface having a surface area, wherein at least part of the surface area is capable of detecting liquid, the surface comprising:
a substrate;
optionally an insulating layer covering the substrate; and
a pair of spaced apart conductive lines deposited from a conductive paint applied on the substrate or on the insulating layer, wherein the conductive paint comprises a polymeric binder and a pigment,
   wherein, if the substrate has a resistivity of less than a factor 10 higher than the resistivity of the conductive lines, the surface comprises the insulating layer,
   and wherein the pair of conductive lines is electrically connected to a power source for providing an electric potential difference between the conductive lines in the pair and creating an electric field between the conductive lines in the pair, in such a way that the pair of conductive lines forms a capacitor in a capacitive measurement circuit wherein change in capacitance of the capacitor can be monitored,
   wherein the conductive paint is a liquid paint, and wherein the conductive lines are deposited by applying the liquid conductive paint by brush, roller, or spray, and allowing the applied paint to dry at a temperature in the range of from 0° C. to 40° C.

It has been found that the surface according to the disclosure with one or more painted pairs of conductive lines over a large part of its surface area acts surprisingly well as a liquid detector. It is surprising that lines deposited from conductive paint and with a relatively large surface area can act as a capacitor in a capacitive measurement circuit, despite the relatively low conductivity of conductive paint compared to conductors used in conventional capacitors. Paint conductivity is limited due to restrictions in the amount of pigment, typically the conductive component in a conductive paint. The concentration of pigments must be such that the paint has a pigment volume concentration that is not much higher than its critical pigment volume concentration in order for the paint to be able to form a paint film. It has been found that even when electrodes of conductive paint with a relatively large surface area are applied, changes in capacitance can be detected with sufficient resolution and accuracy. Thus, liquid can be detected over large surface areas, such as surface areas of at least 0.5 or 1.0 square metres.

An important advantage of using conductive lines deposited from paint is that a high temperature heating step, such as a sintering step, is not needed to cure the resin in the conductive paint. Paint typically cures by allowing any paint carrier such as water and/or organic solvent to evaporate at ambient conditions, i.e., at a temperature in the range of from 0° C. to 40° C., preferably of from 10° C. to 35° C. and at atmospheric pressure.

A further advantage of painted conductive lines is that these can be applied with simple techniques such as brushing, rolling, or spraying, enabling scalability of liquid detection to much larger surface areas. More expensive application techniques such as printing as used in prior art liquid detection sensors are not needed.

In a second aspect, the disclosure provides a method of detecting a liquid on a surface, comprising:
providing a surface according to the first aspect of the disclosure;
providing an electric potential difference between the two conductive lines in the pair of conductive lines; and
monitoring change in capacitance of the capacitor.

### SUMMARY OF THE DRAWINGS

FIG. 1 shows a surface according to the disclosure comprising four pairs of conductive lines.

### DETAILED DESCRIPTION

The surface according to the disclosure can detect water or other liquid that is touching the surface, for example because of a leakage or a spill.

The surface comprises a substrate forming the base of the surface. The substrate may be of any suitable material. The substrate may be a conductive substrate such as a metal substrate or a non-conductive substrate. Preferably, the surface substrate is a non-conductive substrate, more preferably a ceramic substrate, a wood substrate, or a polymeric substrate. Examples of suitable ceramic substrates are concrete, stone, brick, or tile substrates. Examples of suitable wood substrates are substrates of solid wood or substrates of engineered wood, for example medium-density fibre board, plywood, particleboard, or oriented strand board. Examples of suitable polymeric substrates are substrates of plastic or of fibre-reinforced polymer.

The surface has a surface area. The surface area may be of any suitable size, preferably at least 0.5 m², more preferably at least 1.0 m². The upper limit of the surface area is not particular critical but will be typically up to 2,000 m² or up to 1,000 m², preferably up to 500 m².

The surface optionally comprises an insulating layer covering the substrate.

The surface comprises a pair of spaced apart conductive lines deposited from a conductive paint applied on the substrate or, if present, on the insulating layer. The pair of conductive lines comprises a first and a second conductive line and serves as a pair of electrodes (a first and a second electrode) that can be used as a capacitor in a capacitive measurement circuit when an electric potential difference is applied over the first and the second electrode. The pair of conductive lines is electrically connected to a power source for providing an electric potential difference between the first and the second electrode in such a way that the first and second electrode form a capacitor in a capacitive measurement circuit. Thus, an electric field is created between the conductive lines (the first and the second electrode) in the pair. By monitoring change in capacitance of the capacitor formed by the first and second electrode, the presence of liquid on the surface can be detected.

It will be appreciated that the two spaced apart conductive lines in the pair must be electrically insulated from each other, so that the two conductive lines can act as a capacitor. Therefore, the layer on which the conductive lines are applied must have a conductivity that is much lower than the conductivity of the conductive lines (or a resistivity that is much higher than the resistivity of the conductive lines). In case the substrate has a resistivity of less than a factor 10 higher than the resistivity of the conductive lines, the surface comprises the insulating layer and the pair of conductive lines substrate is applied on the insulating layer. This will typically be the case for conductive substrates, such as metal substrates. In case the substrate has a resistivity that is at least a factor 10 higher than that of the conductive lines, as will typically be the case for non-conductive substrates such as ceramic, wood, or polymeric substrates, the insulating layer is optional. Thus, the conductive lines are applied on either a non-conductive substrate or on a non-conductive insulating layer.

Reference herein to resistivity is to electrical resistivity. It is the reciprocal of electrical conductivity. Resistivity is a fundamental property of a material and is expressed in the unit ohm-centimeter (Ω·cm). Resistivity is suitably determined according to ASTM D4496-21 for material with a resistivity between 10⁰ to 10⁷ Ω·cm, according to ASTM D257-14 for materials with a resistivity above 10⁷ Ω·cm and according to ASTM B193-20 for materials with a resistivity below 10⁰ Ω·cm. Reference herein to the resistivity of the conductive lines is to the resistivity of the dried conductive paint.

The surface may comprise more than one pairs of conductive lines applied on the substrate or on the insulating layer. In case of more than one pairs, each of the pairs is electrically connected to a power source and forms a capacitor in a capacitive measurement circuit as described above.

The conductive lines in the pair (the first and second electrode) are spaced apart and do not cross each other. The shape of the conductive lines is not critical. The conductive lines may have any suitable shape and any suitable size. Preferably, the shape is such that the first and second electrode are spaced apart at a constant distance. The two lines in one pair may be straight parallel lines. Alternatively, each line in one pair may be branched and the branches of each line in the pair are intertwined. Alternatively, the lines may be in the shape of concentric circles.

Preferably, each conductive line in the pair independently has a surface area in the range of from 10 cm² to 10,000 cm², more preferably of from 50 cm² to 5,000 cm², even more preferably of from 100 cm² to 2,000 cm². Preferably, the width of each conductive line in the pair is, independently, in the range of from 0.5 cm to 50 cm, more preferably of from 1.0 cm to 30 cm, even more preferably of from 2.0 cm to 20 cm. Preferably, both lines in a pair have the same width.

The distance at which the two conductive lines in the pair are spaced apart is preferably not more than the width of any one of the two conductive lines. Preferably, the distance is in the range of from 0.4 cm to 50 cm, more preferably of from 0.5 cm to 30 cm, even more preferably of from 1.0 cm to 15 cm, still more preferably of from 2.0 cm to 10 cm.

Preferably, the size, number, and shape of the of pair(s) of conductive lines is such that at least 10%, more preferably at least 25%, even more preferably at least 40%, still more preferably at least 50% or at least 60% of the surface area is covered by the one or more pairs of conductive lines. For calculating the percentage of surface area covered by the pair(s) of conductive lines, the area between two lines in a pair (the surface area of the gaps between the two conductive lines in a pair) is considered surface area covered by the pair(s) of conductive lines. Thus, at least 10%, 25%, 40%, 50%, or 60% of the surface area is capable of detecting liquid leaked or spilled on it.

The conductive lines deposited from a conductive paint may have any suitable thickness. Preferably, the lines have a thickness (dry film thickness) in the range of from 30 μm to 300 μm, more preferably of from 40 μm to 200 μm, even more preferably of from 50 μm to 150 μm, still more preferably of from 60 μm to 120 μm.

The surface may further comprise an electric shielding layer. The electric shielding layer is a conductive layer that shields the capacitor formed by the pair of conductive lines from external influences such as for example humidity in the substrate. Such electric shielding layer may be present at the same side or at the opposite site of the substrate with respect to the side on which the optional insulating layer and the conductive lines are applied. If the electric shielding layer is present at the same side of substrate as the conductive lines, an insulating layer as described herein must be present between the electric shielding layer and the pair of conductive lines. The electric shielding layer may be any suitable conductive layer such as for example a metal foil or a coating deposited from a conductive paint. If the conductive layer is a coating deposited from a conductive paint, the conductive paint may be the same as or different from the paint from which the pair of conductive lines is deposited, preferably the same.

The thickness of the electric shielding layer is not critical, it may have any suitable thickness. Preferably, the electric shielding layer has a thickness in the range of from 30 μm to 300 μm, more preferably of from 50 μm to 200 μm, even more preferably of from 70 μm to 150 μm.

Preferably, the electric shielding layer has a resistivity below 1,000 Ω·cm, more preferably below 10 Ω·cm.

The insulating layer is applied directly on the substrate or on the electric shielding layer. The insulating layer may be of any suitable material, provided the layer electrically insulates the conductive lines in the pair from each other. The insulating layer is thus made of a non-conductive material, preferably a material with a resistivity of at least 1.104 Ω·cm, more preferably at least 1.106 Ω·cm, even more preferably in the range of from 1.106 Ω·cm to 1.1012 Ω·cm. The insulating layer may for example be a paint layer deposited from a non-conductive paint, a non-conductive coating layer, or a polymeric laminate. If the insulating layer is a polymeric laminate, it may be applied on the substrate or on the shielding layer by using an adhesive. Preferably, the insulating layer is a paint layer deposited from a non-conductive paint or is a non-conductive coating layer.

The insulating layer may have any suitable thickness. Preferably, the insulating layer has a thickness in the range of from 30 μm to 300 μm, more preferably of from 50 μm to 200 μm, even more preferably of from 70 μm to 150 μm, still more preferably of from 80 μm to 120 μm.

The pair of conductive lines are deposited from a conductive paint. Reference herein to a paint is to a coating composition, preferably a liquid coating composition, that can be applied on a surface by brush, roller, or spraying and that forms a film by allowing it to dry at ambient conditions, i.e., at a temperature in the range of from 10° C. to 35° C. and at atmospheric pressure. No heating step is required to have a film formed by a paint. A liquid paint typically comprises a film-forming polymeric binder, pigment (color pigment and/or extender pigment), and additives in a liquid carrier material such as water or organic solvent. The polymeric binder holds the paint together and provides adhesion.

The conductive paint comprises a polymeric binder and a pigment. Preferably, the conductive paint is a liquid paint.

Preferably the conductive paint is a liquid paint, and the conductive lines are deposited by applying the liquid conductive paint by brush, roller, or spray, and allowing the applied paint to dry at a temperature in the range of from 0° C. to 40° C., preferably of from 10° C. to 35° C., at atmospheric pressure.

Preferably, the conductive paint comprises at least 25 wt % polymeric binder, more preferably at least 30 wt % polymeric binder, based on the solid weight of the conductive paint.

The conductive paint may comprise a conductive polymeric binder and/or a conductive pigment. Conductive polymeric binders are known in the art and include polymeric binders with ionic groups, such as for example sulphonate groups, and polymers with a high density of conjugated double bonds. Examples of polymeric binders are poly(3,4-ethylenedioxythiophene):poly(styrene sulfonate), polyacetylene, polyaniline, polypyrrole, polythiophene, poly(para-phenylene), poly(phenylenevinylene), and polyfuran.

Preferably, the conductive paint comprises a polymeric binder and a conductive pigment, more preferably a non-conductive binder and a conductive pigment. After drying of the paint, the conductive pigment then provides an electric pathway in a non-conductive polymeric binder. The non-conductive binder may be any suitable binder known for paints. The type of non-conductive binder is not critical for the conductive properties of the paint and will mainly be determined by other requirements such as for example adhesion properties, chemical resistance, and durability of the painted lines. Examples of suitable non-conductive polymeric binders include (meth)acrylic (co)polymers, polyvinyl (co)polymers, epoxy-based binders, polyurethane binders, polyester binders, alkyd-based binders, and combinations thereof. Preferably, the conductive paint comprises a (meth)acrylic (co)polymer binder, a polyvinyl (co)polymer binder, an epoxy-based binder, a polyurethane binder, or combinations thereof.

In case the conductive paint comprises a non-conductive polymeric binder and a conductive pigment, the conductive lines deposited from the conductive paint preferably have a resistivity in the range of from 0.03 to 3,000 Ω·cm, more preferably of from 0.1 to 1,000 Ω·cm.

In case the paint comprises a conductive polymeric binder, it does not need to comprise a conductive pigment. It may comprise conductive and/or non-conductive pigments. In case the paint comprises a conductive polymeric binder, it will typically have a resistivity in the range of from 1·10⁻⁴ to 1·10⁻¹ Ω·cm.

The conductive pigment may be any conductive pigment known in the art. The conductive pigment may have any suitable shape, such as for example sphere, flake, or tube.

The conductive pigment is preferably present in a concentration above its percolation threshold in the polymeric binder. The paint may comprise a combination of conductive and non-conductive pigments. The total pigment concentration, i.e., the sum of the concentration of non-conductive and conductive pigments, is preferably not more than five percentage points above the critical pigment volume concentration, more preferably not more than the critical pigment volume concentration. The critical pigment volume concentration is the pigment concentration at which the pigments are packed as close as possible, and the polymer binder is exactly the amount required to fill any space between the pigments. It will be appreciated that the desired concentration of conductive pigment strongly depends on the shape of the conductive pigment, since tubular or flake-type conductive pigments will be above its percolation threshold at a much lower concentration than spherical pigments.

Preferably, the conductive pigment is a carbon pigment, a metal pigment, a metal-coated pigment, or a mixture thereof. Examples of suitable carbon pigments include carbon black, graphite, activated carbon powder, graphene nanotubes, and carbon nanotubes. Examples of suitable metal pigments include silver, copper, and nickel pigments. Examples of suitable metal-coated pigments include silver-coated-copper and metal coated ceramic particles.

Carbon black is a particularly preferred conductive pigment.

In case the conductive pigment is carbon black, it is preferably present in a concentration in the range of 30 to 75 wt %, more preferably of from 35 to 70 wt %, based on the solid weight of the conductive paint. For tubular conductive pigment, such as for example graphene nanotubes, the concentration may be as low as 0.5 wt % or 1.0 wt % to provide a conductive paint suitable for the present disclosure.

The paint may be a solventborne or waterborne paint.

The paint may comprise further ingredients commonly used in paint such as coalescence solvent, non-conductive color pigments, extender pigments (often referred to as fillers), biocides, and paint additives such as for example rheology modifiers, surfactants, defoaming agents, and leveling agents.

The surface may further comprise a topcoat covering at least part of the pair(s) of conductive lines and covering any space between such lines. The topcoat may be any suitable topcoat. The topcoat may protect the conductive lines, the underlying substrate, and any underlying layers from external influences and may provide aesthetic properties such as a desired color. The topcoat may be any suitable coating. The topcoat may be a clear or an opaque topcoat. The topcoat preferably has a resistivity of at least a factor 100 higher than the resistivity of the conductive lines, so that it will not affect the electric field between the electrodes formed by the conductive lines.

The pair of conductive lines is electrically connected to a power source for providing an electric potential difference between the conductive lines in the pair and creating an electric field between the conductive lines in the pair, in such a way that the pair of conductive lines forms a capacitor in a capacitive measurement circuit wherein change in capacitance of the capacitor can be monitored.

Such capacitive measurement circuit including the capacitor may for example be formed by electrically connecting each electrode in the pair, typically with a wire, to an input channel of a capacitance-to-digital converter or other unit that is able to form a capacitive measurement circuit and to measure any changes in capacitance of the capacitor. The electric potential difference between the conductive lines in the pair may be provided by a battery or other power source in such unit or connected to such unit. A processor, e.g., a laptop or other computer, may be connected to such unit to process any change in capacitance measured by the unit into a signal that may for example be displayed on a screen, sent to a mobile phone, or converted into a sound signal in an alarm system.

In case the surface comprises a plurality of pairs of conductive lines, each pair is electrically connected to a power source and forms a capacitor in a capacitive measurement circuit as described hereinabove. The power source may be the same or a different power source for each pair, preferably the same power source. The several capacitive measurement circuits thus created may be arranged in series or in parallel to create a single signal for the change in capacitance. Alternatively, change in capacitance for each capacitive measurement circuit may be measured separately and independently and processed separately to be able to detect liquid at different parts of the surface. Thus, spatial resolution in liquid detection can be achieved.

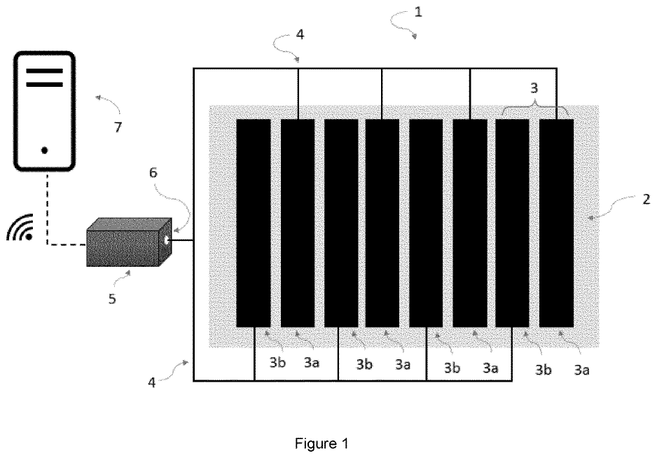

In FIG. 1 is shown an example of a surface 1 comprising a substrate 2 on which four pairs 3 of conductive lines (3a, 3b) have been painted. Each pair comprises a first conductive line 3a and a second conductive line 3b. The conductive lines (electrodes) are electrically connected via wires 4 to capacitance-to-digital converter 5. Converter 5 provides an electric potential difference over each pair 3 of electrodes 3a and 3b (via a battery (not shown) in convertor 5). In the embodiment of FIG. 1, the electrode pairs 3 are arranged in parallel and are all connected to a single input channel 6 of convertor 5. Any change in capacitance is measured and processed into a signal in convertor 5 that is sent via a wireless connection to mobile phone 7. In the embodiment of FIG. 1, the larger part of the surface area of surface 1 is covered by the pairs 3 of conductive lines, i.e., the surface area covered by the lines and the spaces between the lines.

The surface may be any suitable surface. Detection of liquid is particularly relevant for building surfaces such as floors, walls, or ceilings. Preferably the surface is a floor, a ceiling, or a wall, more preferably a floor.

Any liquid that has an electric permittivity different from the electric permittivity of air can be detected. The liquid may for example be water, oil, an organic liquid, brine, a liquid food, medical, or chemical composition, a reaction mixture from a chemical reactor, etc. A particularly preferred liquid is water.

The surface according to the first aspect of the disclosure is particularly suitable for detecting liquid, in particular water, on a large part of its surface area.

In a second aspect, the disclosure provides a method of detecting a liquid on a surface, comprising:
providing a surface according to the first aspect of the disclosure;
providing an electric potential difference between the two conductive lines in the pair of conductive lines; and
monitoring change in capacitance of the capacitive circuit.

Any preferred ranges, features, or embodiments described above for the surface according to the disclosure are also preferred ranges, features, or embodiments for the method according to the disclosure.

The disclosure is further illustrated by means of the following non-limiting examples.

### EXAMPLES

### Example 1

An aqueous base paint composition was prepared by mixing two different aqueous acrylic binders, coalescence solvent, thickener, adhesion promoter, a defoaming agent and a small amount of water in the weight parts given in Table 1 for Example 1. A conductive paint was prepared by mixing 57 wt % of the aqueous paint base composition with 43 wt % of an aqueous pigment paste (60 wt % water; 40 wt % carbon black pigment). A biocide (0.01 wt %) was then added.

The conductive paint thus prepared comprised 51.6 wt % acrylic binder polymer on total solids and 47.3 wt % conductive pigment (carbon black) on total solids weight.

TABLE 1
Conductive paints for Examples 1 and 2

| | | Example 1 | | Example 2 | |
|---|---|---|---|---|---|
| | Solids | | Solids | | Solids |
| | content | Weight | weight | Weight | weight |
| | (wt %) | parts | parts | parts | parts |
| Base paint | | | | | |
| Aqueous dispersion of | 40 | 23.8 | 9.5 | 27.1 | 10.9 |
| self-crosslinking acrylic | | | | | |
| copolymer^{a} | | | | | |
| Aqueous self- | 39 | 23.8 | 9.3 | 27.1 | 10.6 |
| crosslinking acrylic | | | | | |
| emulsion^{b} | | | | | |
| Coalescence solvent | 0 | 5.2 | 0 | 5.9 | 0 |
| Thickener | 20 | 1.6 | 0.32 | 1.9 | 0.37 |
| Adhesion promoter | 20 | 0.25 | 0.05 | 0.28 | 0.06 |
| Defoaming agent | 24 | 0.12 | 0.03 | 0.14 | 0.03 |
| Water | 0 | 2.2 | 0 | 2.6 | 0 |
| Pigment paste with | 40 | 43 | 17.2 | 35 | 14 |
| carbon black^{c} | | | | | |
| Total | | 100 | 36.4 | 100 | 35.9 |
| biocide | | 0.01 | | 0.01 | |

^{a}Setaqua ® 6754
^{b}Joncryl 1980-E
^{c}Levanyl Black

A medium-density fibreboard (MDF) substrate of 100 cm×200 cm was sanded and wiped with a tack rag to remove any dust. The substrate was then covered with an insulating layer by applying a layer (dry film thickness of 100 μm) of a commercially available epoxy-based two-component floor coating composition (Wapex 660, ex. AkzoNobel) with a roller. The insulating layer was allowed to dry for 16 hours and then eight parallel lines of the conductive paint prepared as described above were applied with a paint roller on the dried insulating layer. The dry film thickness was 70 μm. Each line had a length of 80 cm and a width of 10 cm and the distance between neighbouring parallel lines was 2 cm. The conductive paint was allowed to dry at 23° C. and 50% relative humidity for 16 hours. Thus, four pairs of conductive lines were formed. The dried conductive paint had a resistivity of 3 Ω·cm.

Each line deposited from the conductive paint was electronically connected to a capacitance-to-digital converter by means of a copper wire that was attached to the end of the line via a copper strip attached to the line.

A topcoat of a commercially available epoxy-based two-component floor coating composition (Wapex 660, ex. AkzoNobel) was then roller applied, covering the dried lines of conductive paint and any insulating layer not covered by the conductive paint.

For each pair of neighbouring lines, the two copper wires were connected to an input channel of a capacitance-to-digital converter to form a capacitance measurement circuit including the two conductive lines (electrodes) in the pair as capacitor. The copper wires of each pair were connected to a different input channel of the capacitance-to-digital converter. The capacitance-to-digital converter provided an electric potential difference over the two conductive lines in the pair. The capacitance-to-digital converter measured any change in capacitance in the four circuits separately and independently and was connected to a laptop for processing any changes in capacitance in any of the four capacitors into a signal that was displayed on the monitor. The laptop battery served as the power source for providing electric potential difference over each pair of conductive lines.

Whilst monitoring capacitance of the four capacitors, two millilitres of water was sprayed on part of the surface covering about 0.1% of the entire surface. A change of 28% in capacitance was measured for the electrodes at the location of water spraying.

### Example 2

An aqueous base paint composition was prepared by mixing two different aqueous acrylic binders, coalescence solvent, thickener, adhesion promoter, a defoaming agent and a small amount of water in the weight parts given in Table 1 for Example 2. A conductive paint was prepared by mixing 65 wt % of the aqueous paint base composition with 35 wt % of an aqueous pigment paste (60 wt % water; 40 wt % carbon black pigment). A biocide (0.01 wt %) was then added.

The conductive paint thus prepared comprised 59.9 wt % acrylic binder polymer on total solids and 39.0 wt % conductive pigment (carbon black) on total solids.

A concrete substrate of 70 cm×80 cm was scoured by hand using a scotchbrite pad, wiped with a cloth to remove any particles, and then wiped with water. The substrate was then allowed to dry for 16 hours at 23° C. and 50% relative humidity. The dried substrate was then covered with an insulating layer by applying a layer (dry film thickness of 100 μm) of a commercially available epoxy-based two-component floor coating composition (Wapex 660, ex. AkzoNobel) with a roller.

The insulating layer was allowed to dry for 16 hours at 23° C. and 50% relative humidity and then two parallel lines of the conductive paint prepared as described above were applied with a paint roller on the dried insulating layer. The dry film thickness was 70 μm. Each line had a length of 80 cm and a width of 30 cm and the distance between the two parallel lines was 10 cm. The conductive paint was allowed to dry at 23° C. and 50% relative humidity for 16 hours. The dried conductive paint had a resistivity of 7 Ω·cm.

The two lines deposited from the conductive paint were each electronically connected to the same input channel of a capacitance-to-digital converter by means of a copper wire that was attached to the end of the line via a copper strip attached to the line. Thus, a capacitance measurement circuit including the two conductive lines as capacitor was formed. The capacitance-to-digital converter provided an electric potential difference over the two conductive lines. Any change in capacitance was monitored.

Whilst monitoring capacitance of the capacitor, 20 millilitres of water was sprayed on the surface covering about 5% of the entire surface. A change of 30% in capacitance was measured.

### Example 3

A conductive paint was prepared by mixing a base paint comprising an epoxy resin with a polyamine hardener. The composition and amounts of the base paint and hardener are given in Table 2.

TABLE 2
Conductive paint of Example 3

| | | | Solids |
|---|---|---|---|
| | Solids | Weight | weight |
| | content | parts | parts |
| Base paint | | | |
| n-butylacetate | 0 | 13.8 | |
| Methylethylketone | 0 | 5.5 | |
| Graphene nanotubes^{a} | 100 | 1.1 | 1.1 |
| Epoxy resin^{b} | 100 | 54.9 | 54.9 |
| Hardener | | | |
| Xylene | 0 | 6.0 | |
| Polyamine-based epoxy curing agent^{c} | 70 | 18.7 | 13.1 |
| Total | | 100 | 69.1 |

^{a}Tuball Matrix 208
^{b}EPIKOTE ™ Resin 828
^{c}Ancamine ® 2500

A carbon steel substrate of 10 cm×20 cm was grit-blasted and then air-blown to remove any steel dust. The substrate was then covered with an insulating layer by spray applying a layer (dry film thickness of 150 μm) of a commercially available epoxy-based two-component coating composition (Intershield 300, ex. AkzoNobel). The insulating layer was allowed to dry for 16 hours at 23° C. and 50% relative humidity and then two parallel lines of the conductive paint prepared as described above were applied with a paint roller on the dried insulating layer. The dry film thickness was 60 μm. Each line had a length of 17 cm and a width of 3 cm and the distance between the two parallel lines was 2 cm. The conductive paint was allowed to dry at 23° C. and 50% relative humidity for 16 hours. The dried conductive paint had a resistivity of 80 Ω·cm.

The two lines deposited from the conductive paint were each electronically connected to the same input channel of a capacitance-to-digital converter to form a capacitance measurement circuit including the two conductive lines as capacitor.

A topcoat of a commercially available two-component polyurethane-based coating composition (Auroclear Superior Medium, ex. AkzoNobel) was then spray applied, covering the dried lines of conductive paint and any insulating layer not covered by the conductive paint.

Whilst monitoring capacitance of the capacitance measurement circuit, one milliliter of water was sprayed on the surface covering about 1% of the entire surface. A change of 15% in capacitance was measured.

### Example 4

A one-component conductive paint was prepared by mixing the components as shown in Table 3 in the weight parts given in Table 3.

TABLE 3
Conductive paint of Example 4

| | | | Solids |
|---|---|---|---|
| | Solids | Weight | weight |
| | content | parts | parts |
| Aqueous dispersion of polyurethane resin | 28 | 12.5 | 3.5 |
| Aqueous dispersion of (meth)acrylic resin | 25 | 26.2 | 6.6 |
| Carbon black powder | 100 | 21.5 | 21.5 |
| Additives | | 1.9 | |
| Coalescence solvent (butyl glycol) | 0 | 1.5 | |
| fungicide | 48.5 | 0.1 | |
| water | 0 | 36.3 | |
| Total | | 100 | 36.1 |

A panel of solid wood (Spruce) substrate of 50 cm×25 cm was sanded, wiped with a cloth to remove dust, and wiped with water. The substrate was then allowed to dry for 16 hours at 23° C. and 50% relative humidity. The dried substrate was covered at its bottom surface with aluminium foil as an electric shielding layer and on its upper surface an insulating layer was applied by applying a layer (dry film thickness of 50 μm) of a commercially available waterborne acrylate-based one-component floor coating composition (Stelfloor 1K, ex. AkzoNobel) with a roller. The insulating layer was allowed to dry for 16 hours at 23° C. and 50% relative humidity and then two parallel lines of the conductive paint prepared as described above were applied with a paint roller on the dried insulating layer. The dry film thickness was 60 μm. Each line had a length of 25 cm and a width of 20 cm and the distance between the two parallel lines was 2 cm. The conductive paint was allowed to dry at 23° C. and 50% relative humidity for 16 hours. The dried conductive paint had a resistivity of 2 Ω·cm.

The two lines deposited from the of conductive paint were each electronically connected to the same input channel of a capacitance-to-digital converter to form a capacitance measurement circuit including the two conductive lines as capacitor.

A topcoat of a commercially available waterborne acrylate-based one-component floor coating composition (Stelfloor 1K, ex. AkzoNobel) was then applied, covering the dried lines of conductive paint and any insulating layer not covered by the conductive paint.

Whilst monitoring capacitance of the capacitor, one milliliter of water was sprayed on the surface covering about 0.5% of the entire surface. A change of 30% in capacitance was measured.

### Example 5

A concrete substrate of 80 cm by 100 cm was scoured by hand using a Scotch-Brite pad, wiped with a cloth to remove any particles, and then wiped with water. The substrate was then allowed to dry for 16 hours at 23° C. and 50% relative humidity. Eight parallel lines of the conductive paint prepared as described in EXAMPLE 2 were applied with a paint roller on the substrate. The dry film thickness was 90 μm. Each line had a length of 80 cm and a width of 10 cm and the distance between the two parallel lines was 2 cm. The conductive paint was allowed to dry at 23° C. and 50% relative humidity for 16 hours. The dried conductive paint had a resistivity of 3 Ω·cm.

The lines deposited from the conductive paint were all electronically connected to a capacitance-to-digital converter by means of a copper wire that was attached to the end of the line via a copper strip attached to the line.

For each pair of neighbouring conductive lines, the two copper wires were connected to an input channel of a capacitance-to-digital converter to form a capacitance measurement circuit including the two conductive lines (electrodes) in the pair as capacitor. The copper wires of each pair were connected to a different input channel of the capacitance-to-digital converter and change in capacitance was measured per channel in the same way as described in EXAMPLE 1.

Whilst monitoring capacitance of the capacitor, one millilitre of water was sprayed on the surface covering about 0.05% of the entire surface. A change of 30% in capacitance was measured for the electrodes at the location of water spraying.

1. A building surface having a surface area, wherein at least part of the surface area is capable of detecting liquid, the surface comprising:
a substrate;
optionally an insulating layer covering the substrate; and
a pair of spaced apart conductive lines deposited from a conductive paint applied on the substrate or on the insulating layer, wherein the conductive paint comprises a polymeric binder and a pigment,
wherein, if the substrate has a resistivity of less than a factor 10 higher than the resistivity of the conductive lines, the surface comprises the insulating layer,
and wherein the pair of conductive lines is electrically connectable to a power source for providing an electric potential difference between the conductive lines in the pair and creating an electric field between the conductive lines in the pair, in such a way that the pair of conductive lines forms a capacitor in a capacitive measurement circuit wherein change in capacitance of the capacitor can be monitored,
wherein the conductive paint is a liquid paint, and wherein the conductive lines are deposited by applying the liquid conductive paint by brush, roller, or spray, and allowing the applied paint to dry at a temperature in the range of from 0° C. to 40° C.;
wherein the building surface is a floor, wall or ceiling;
characterized in that the surface area is at least 1.0 m²;
wherein the conductive lines have a width in the range of from 0.5 cm to 50 cm; and
wherein at least 25% of the surface area is covered by the pair(s) of conductive lines.

2. The surface according to claim 1, wherein the substrate is a ceramic substrate, a wood substate, or a polymeric substrate.

3. The surface according to claim 1, wherein the surface is a floor.

4. The surface according to claim 1, wherein the conductive lines have a width in the range of from 1.0 cm to 30 cm.

5. The surface according to claim 1, wherein the conductive lines within the pair are spaced apart at a distance in the range of from 0.4 cm to 50 cm, preferably of from 0.5 cm to 30 cm.

6. The surface according to claim 1, wherein at least 40% of the surface area, preferably at least 50%, is covered by the pair(s) of conductive lines.

7. The surface according to claim 1, wherein the paint comprises at least 25 wt % polymeric binder, based on the solid weight of the conductive paint.

8. The surface according to claim 1, wherein the conductive paint comprises a conductive pigment, preferably a non-conductive polymeric binder and a conductive pigment.

9. The surface according to claim 8, wherein the conductive paint comprises a non-conductive polymeric binder and a conductive pigment and wherein the conductive lines have a resistivity in the range of from 0.03 to 3,000 Ω·cm.

10. The surface according to claim 8, wherein the conductive pigment is carbon black.

11. The surface according to claim 10, wherein the conductive paint comprises carbon black in a concentration in the range of from 30 to 75 wt %, based on the solid weight of the conductive paint.

12. The surface according to claim 1, further comprising a topcoat applied over the pair(s) of conductive lines and over any space between such lines.

13. The surface according to claim 1, wherein the liquid is water.

14. A method of detecting liquid on a surface, comprising:
providing a surface according to claim 1;
providing an electric potential difference between the two conductive lines in the pair of conductive lines; and
monitoring change in capacitance of the capacitor.
